(19) United States
(12) Patent Application Publication
(10) Pub. No.: US 2017/0173605 A1
(43) Pub. Date: Jun. 22, 2017

(54) ELECTROSTATIC ATOMIZING DEVICE AND ELECTROSTATIC ATOMIZING METHOD

(71) Applicant: Panasonic Intellectual Property Management Co., Ltd., Osaka (JP)

(72) Inventors: AYAKA TOMODA, Kyoto (JP); YUKIKO MISHIMA, Osaka (JP); YASUHIRO KOMURA, Osaka (JP); HIROSHI SUDA, Osaka (JP)

(21) Appl. No.: 15/301,940

(22) PCT Filed: Jun. 30, 2015
(86) PCT No.: PCT/JP2015/003275

§ 371 Date: Oct. 4, 2016

(30) Foreign Application Priority Data
Jul. 11, 2014 (JP) 2014-142972

(51) Int. Cl. B05B 5/00; B05B 5/057; B05B 5/053

(52) U.S. Cl. CPC B05B 5/006; B05B 5/053; B05B 5/057

(57) ABSTRACT

An electrostatic atomizing device includes a discharge section capable of retaining a liquid, a voltage applying section for applying a voltage to the discharge section, and a control section for setting the voltage applied by the voltage applying section to a given voltage at which a charged particulate water can be produced in an amount equal to or greater than a given amount. The control section is configured to set the voltage applied by the voltage applying section to a voltage lower than the given voltage at an operation start, and then to change the lower voltage to the given voltage. The electrostatic atomizing device can shorten a time needed before the electrostatic atomizing phenomenon occurs.

### TECHNICAL FIELD

The present disclosure relates to an electrostatic atomizing device that produces a charged particulate water, and an electrostatic atomizing method.

### BACKGROUND ART

An electrostatic atomizing device is known for producing charged particulate water by applying a high voltage to an electrode that retains water. An application of a high voltage to this electrode that retains no water will cause an air discharge and the charged particulate water will not be produced. This air discharge could accelerate the degradation of the electrode.

To deter the electrode from degrading caused by the air discharge, it has been proposed that a voltage applied to the electrode at an operation start be gradually increased (e.g. disclosed in patent literature 1).

### CITATION LIST

Patent Literature: Unexamined Japanese Patent Application Publication No. 2009-125720

### SUMMARY OF INVENTION

To mount this kind of electrostatic atomizing device to an appliance that is used regularly within a short time (e.g. hair dryer), it is necessary to shorten a time as short as possible from an operation start of the electrostatic atomizing device until the device starts producing a charged particulate water.

The present disclosure aims to provide an electrostatic atomizing device and an electrostatic atomizing method that are capable of shortening the time needed before the electrostatic atomizing phenomenon occurs.

An electrostatic atomizing device in accordance with one aspect of the present disclosure comprises the following structural elements:
a discharge section capable of retaining a liquid;
a voltage applying section for applying a voltage to the discharge section; and
a control section for controlling the voltage applied from the voltage applying section.

The control section is configured to set the applied voltage to a first voltage at the operation start, and then to set the applied voltage to a second voltage higher than the first voltage. The second voltage is a predetermined voltage at which a desirable amount of the charged particulate water is produced.

According to this aspect of the present disclosure, the time needed before the electrostatic atomizing phenomenon occurs can be shorter than a case where a predetermined voltage is applied for producing a desirable amount of the charged particulate amount, or a case where the applied voltage is increased gradually.

The foregoing aspect proves that the electrostatic atomizing device and the electrostatic atomizing method are obtainable for shortening the time needed before the electrostatic atomizing phenomenon occurs.

### BRIEF DESCRIPTION OF DRAWINGS

FIG. 1 is a graph illustrating a relation between a voltage applied to a discharge section and a time elapsed in an electrostatic atomizing device in accordance with a first embodiment.

FIG. 2 is a block diagram illustrating schematically the electrostatic atomizing device in accordance with the first embodiment.

FIG. 3 is a block diagram illustrating specifically a structure of the electrostatic atomizing device in accordance with the first embodiment.

FIG. 4 is a graph showing a relation between a voltage applied to an atomizing electrode and a time needed before the electrostatic atomizing phenomenon occurs.

FIG. 5 is a flowchart illustrating an operation of the electrostatic atomizing device in accordance with the first embodiment.

FIG. 6 is a block diagram illustrating specifically a structure of an electrostatic atomizing device in accordance with a second embodiment.

FIG. 7 is a graph illustrating a relation between a voltage applied to an atomizing electrode (the discharge section) and a time elapsed in the electrostatic atomizing device in accordance with the second embodiment.

FIG. 8 is a graph showing a relation between a discharge current and a time elapsed from an operation start of the electrostatic atomizing device in accordance with the second embodiment.

FIG. 9 is a flowchart showing an operation of the electrostatic atomizing device in accordance with the second embodiment.

FIG. 10 is a block diagram illustrating specifically a structure of an electrostatic atomizing device in accordance with a third embodiment.

FIG. 11 is a flowchart showing an operation of the electrostatic atomizing device in accordance with the third embodiment.

### DETAILED DESCRIPTION OF PREFERRED EMBODIMENTS

An electrostatic atomizing device in accordance with one aspect of the present disclosure comprises the following structural elements:
a discharge section capable of retaining a liquid;
a voltage applying section for applying a voltage to the discharge section; and
a control section for controlling the voltage applied from the voltage applying section.

The control section is configured to set the applied voltage to a first voltage at the operation start, and then to set the applied voltage to a second voltage higher than the first voltage. The second voltage is a predetermined voltage at which a desirable amount of the charged particulate water is produced.

According to this aspect of the present disclosure, the time needed before the electrostatic atomizing phenomenon occurs can be shorter than a case where a predetermined voltage is applied for producing a desirable amount of the charged particulate water, or a case where the applied voltage is increased gradually.

An electrostatic atomizing device in accordance with a second aspect of the present disclosure is configured to set the applied voltage to a third voltage different from the second voltage. The third voltage is set after the second voltage has been set in the first aspect.

According to this second aspect, the setting of the third voltage allows producing no charged particulate water, so that multiple modes (e.g. a mode of greater production amount of the charged particulate water, a mode of smaller production amount of the charged particulate water) can be set for users to use the device conveniently.

An electrostatic atomizing device in accordance with a third aspect of the present disclosure is configured to set the third voltage to a voltage equal to the first voltage set in the first aspect. According to the third aspect, a structure of controlling the voltage can be simplified.

An electrostatic atomizing device in accordance with a fourth aspect of the present disclosure is configured to set the first voltage to a voltage at which minus ions are produced in the discharge section. According to the fourth aspect, the minus ions can be produced until the electrostatic atomization starts.

A fifth aspect of the present disclosure introduces an electrostatic atomizing method for producing the charged particulate water by applying a voltage to a liquid accommodated in the discharge section. The electrostatic atomizing method of the fifth aspect includes the following steps:

a first step of applying a first voltage to the liquid at the operation start; and

a second step of applying a second voltage higher than the first voltage to the liquid. A given amount of the charged particulate water is produced at the second voltage.

According to this fifth aspect of the present disclosure, the time needed before the electrostatic atomizing phenomenon occurs can be shorter than a case where the second voltage is applied to the discharge section, or a case where the applied voltage is increased gradually.

A sixth aspect of the present disclosure introduces an electrostatic atomizing method that further comprises a step of applying a third voltage different from the second voltage. The third voltage is applied, after the second step in the fifth aspect, to the liquid.

According to this sixth aspect, the application of the third voltage allows producing no charged particulate water, so that multiple modes (e.g. a mode of greater production amount of the charged particulate water, a mode of smaller production amount of the charged particulate water) can be set for users to use the device conveniently.

In the method discussed above, the first voltage can be equal to the third voltage.

In the method discussed above, the first voltage can be the voltage at which the minus ions can be produced in the discharge section.

Examples of the electrostatic atomizing device are demonstrated hereinafter with reference to the accompanying drawings. The electrostatic atomizing device is a device for producing the charged particulate water, which contains active species, or contains acid chemical species as well as active species.

The active species include at least one of hydroxyl radical, superoxide, nitric oxide radical, and oxygen radical.

The acid chemical species include at least one of nitride acid, nitric acid hydrate, nitrous acid, and nitrous acid hydrate. The acid chemical species becomes an acid component of the charged particulate water.

### First Exemplary Embodiment

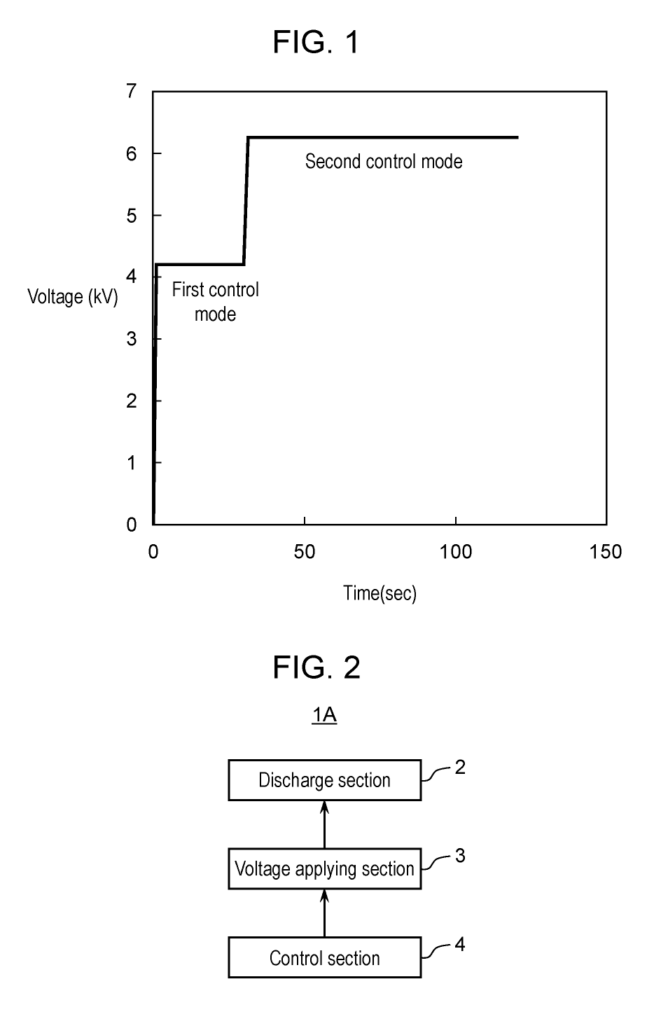

Electrostatic atomizing device 1A in accordance with the first embodiment is demonstrated hereinafter with reference to FIG. 1 and FIG. 2. FIG. 1 is a graph illustrating a relation between a voltage applied to discharge section 2 of device 1A and a time elapsed.

The vertical axis of the graph shows a voltage (kV) applied to discharge section 2, and the lateral axis thereof shows an amount of time elapsed (sec.) from the operation start of device 1A. FIG. 2 is a block diagram illustrating schematically electrostatic atomizing device 1A in accordance with the first embodiment. Device 1A includes discharge section 2, voltage applying section 3, and control section 4.

Discharge section 2 is capable of retaining a liquid, and an application of a given voltage thereto will cause an electric discharge. Water is taken as an example of the liquid in this demonstration. A physical structure of discharge section 2 does not limit the principle of the first embodiment.

Voltage applying section 3 applies a given first voltage or a given second voltage higher than the first one to discharge section 2. In the context below, the “given voltage” refers to not only a strict constant voltage, but also an approx. constant voltage.

Control section 4 controls voltage applying section 3 at the operation start such that a first control mode can be executed. In the first control mode, the first voltage is applied to discharge section 2. After the first control mode, control section 4 controls voltage applying section 3 such that a second control mode is executed. In the second control mode, the second voltage higher than the first one is applied to discharge section 2.

In the first control mode, an air discharge state is kept until the production start of charged particulate water. In the second control mode, the charged particulate water is produced. In other words, the second voltage is the given voltage at which device 1A produces a desirable amount of charged particulate water.

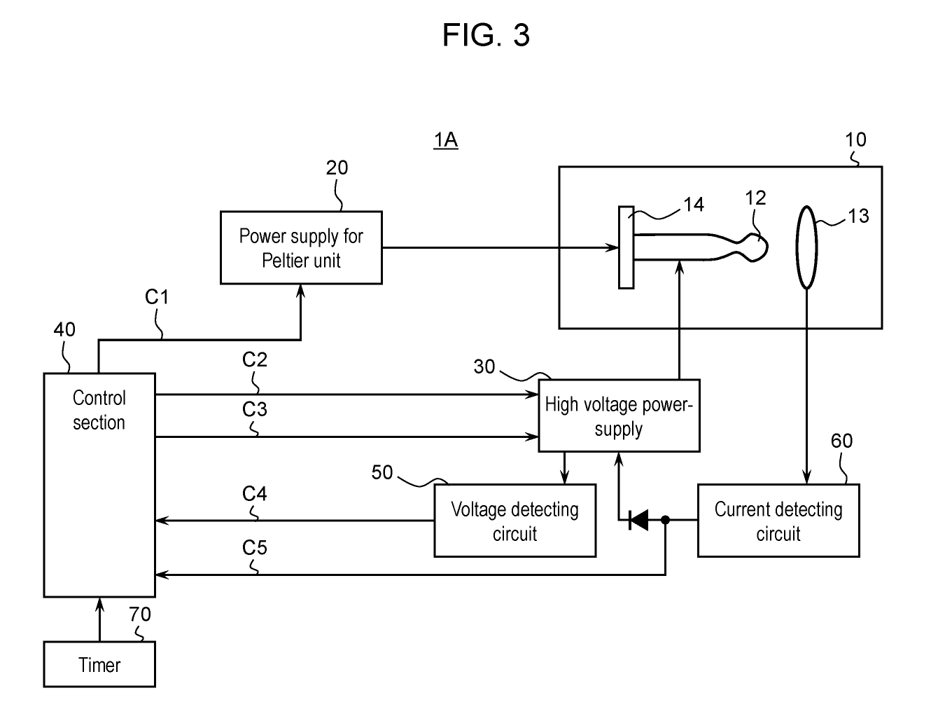

FIG. 3 is a block diagram illustrating specifically a structure of electrostatic atomizing device 1A in accordance with the first embodiment. Device 1A includes atomizing block 10, power-supply 20 for a Peltier unit, high-voltage power supply circuit 30, control section 40, voltage detecting circuit 50, current detecting circuit 60, and timer 70.

Atomizing block 10 includes atomizing electrode 12, counter electrode 13 facing atomizing electrode 12, Peltier unit 14 for cooling atomizing electrode 12. Atomizing electrode 12 and counter electrode 13 work as discharge section 2 shown in FIG. 2. Discharge section 2 can be in a structure that does not have counter electrode 13.

Power-supply 20 for Peltier unit 14 feeds power to Peltier unit 14, which then cools atomizing electrode 12 to produce a dew thereon. In other words, Peltier unit 14 and power-supply 20 work as a water supplier to atomizing electrode 12.

Nevertheless the water supplier to atomizing electrode 12 does not always include Peltier unit 14. For instance, an electrode formed of water absorber is used for drawing up a water by capillarity from a liquid retainer prepared separately, or for absorbing a water in the air directly. The water supplier can employ one of these methods available in the public domain.

High voltage power-supply circuit 30 generates a voltage to be applied to atomizing electrode 12 (hereinafter referred to as an applied voltage). Circuit 30 works as voltage applying section 3 shown in FIG. 2.

Control section 40 is formed of, for instance, a microcomputer, and works as control section 4 shown in FIG. 2. One of the functions of control section 40 is to send control signal C1 for cooling to power-supply 20 for Peltier unit 14.

Another function of control section 40 is to send control signal C2 for ON/OFF to high voltage power-supply circuit 30. This control signal C2 for ON/OFF includes a command signal for activating circuit 30 and a command signal for halting circuit 30.

A feed of control signal C2 for ON/OFF (i.e. a command signal to activate high voltage power-supply circuit 30) to circuit 30 will activate circuit 30, and a feed of control signal C2 (i.e. a command signal to halt circuit 30) to circuit 30 will halt circuit 30.

Control section 40 feeds voltage-adjusting signal C3, which adjusts a discharge voltage, to high voltage power-supply circuit 30 for adjusting a voltage produced by circuit 30.

Voltage detecting circuit 50 detects a voltage produced by high voltage power-supply circuit 30 (e.g. the first voltage, the second voltage), and then feeds discharge-voltage signal C4, which shows a value of the detected voltage, to control section 40. Based on discharge-voltage signal C4, control section 40 carries out a feedback control on the voltage produced by high voltage power-supply circuit 30.

Current detecting circuit 60 detects a discharge current, and feeds discharge-current signal C5 to control section 40. A value of discharge current during the air discharge differs from that during the electrostatic atomizing phenomenon (i.e. during the production of the charged particulate water), so that control section 40 determines based on the discharge-current signal C5 whether or not the electrostatic atomizing phenomenon occurs.

The charged particulate water is produced through the following mechanism:

An application of a high voltage to atomizing electrode 12 in which a water is stored will cause an electric atomizing, whereby the charged particulate water is produced.

To be more specific, the application of a high voltage to atomizing electrode 12 charges the water stored in electrode 12 with electricity, so that Coulomb's force acts on the water, and then the water surface bulges locally like a cone (i.e. a Taylor cone is formed.).

Since the electric charges gather at the tip of the Taylor cone, the electric field is intensified at the tip. As a result, the Coulomb's force generated at the tip of the Taylor cone becomes greater, so that the Taylor cone grows further.

As the Taylor cone grows, and the electric charges gather at the tip of the Taylor cone to increase the density of electric charges at the tip, then the water at the tip of the Taylor cone receives a great energy (i.e. repulsion of the highly dense electric charges) exceeding the surface tension. As a result, the water breaks up (Rayleigh break-up) and scatters. This process is repeated, which is referred to as the electrostatic atomizing phenomenon.

This electrostatic atomizing phenomenon produces, for instance, a mist of charged particulate in nanometer size.

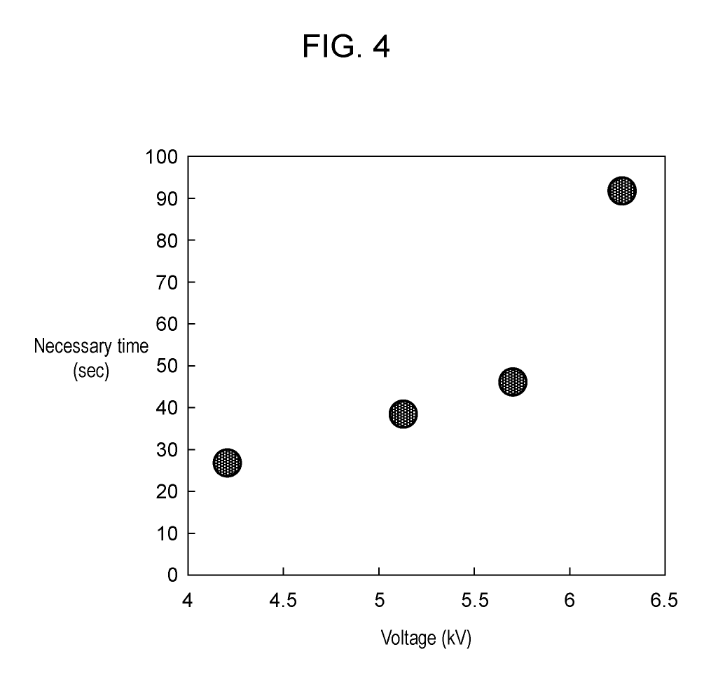

FIG. 4 is a graph showing a relation between a voltage applied to atomizing electrode 12 shown in FIG. 3 and a time (necessary time) needed before the electrostatic atomizing phenomenon occurs. The lateral axis shows a voltage (kV) applied to atomizing electrode 12, and the vertical axis shows a time (second) needed before the electrostatic atomizing phenomenon occurs.

The time needed before the electrostatic atomizing phenomenon occurs refers to a time elapsed from the beginning of the discharge between atomizing electrode 12 and counter electrode 13 (i.e. the operation start of electrostatic atomizing device 1A) until the production start of the charged particulate water.

As FIG. 4 shows the time needed before the electrostatic atomizing phenomenon occurs becomes shorter with a smaller voltage applied to atomizing electrode 12. Therefore, an application of a small voltage to electrode 12 at the operation start of device 1A will shorten the time needed before the electrostatic atomizing phenomenon occurs.

Nevertheless, if a greater amount of charged particulate water and a stable supply thereof are expected from electrostatic atomizing device 1A, high voltage power-supply circuit 30 needs to apply a rather high voltage to atomizing electrode 12.

Control section 40 thus implements the first control mode at the operation start of electrostatic atomizing device 1A such that high voltage power-supply circuit 30 applies a lower voltage (first voltage) than a voltage (second voltage) to atomizing electrode 12, where this second voltage is needed for producing a desirable amount of charged particulate water. After the first control mode, control section 40 implements the second control mode such that circuit 30 applies the second voltage higher than the first one to atomizing electrode 12.

As discussed above, the charged particulate water can be produced within a shorter time than the case in which the second voltage is applied at the operation start or the case in which the applied voltage is increased gradually to the second voltage.

Comparing with the case in which the applied voltage is increased gradually, this first embodiment proves that the desirable amount of the water can be produced by a simple control such as switching a voltage to another voltage. The specific values of the first and second voltages can be set appropriately according to a desirable specification, provided that the first voltage is lower than the second voltage.

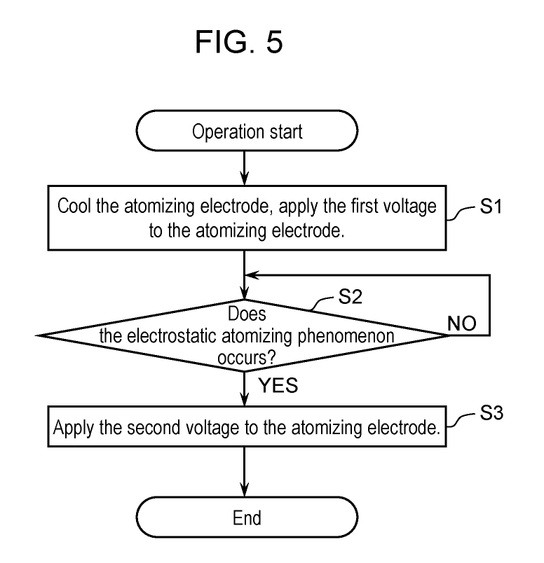

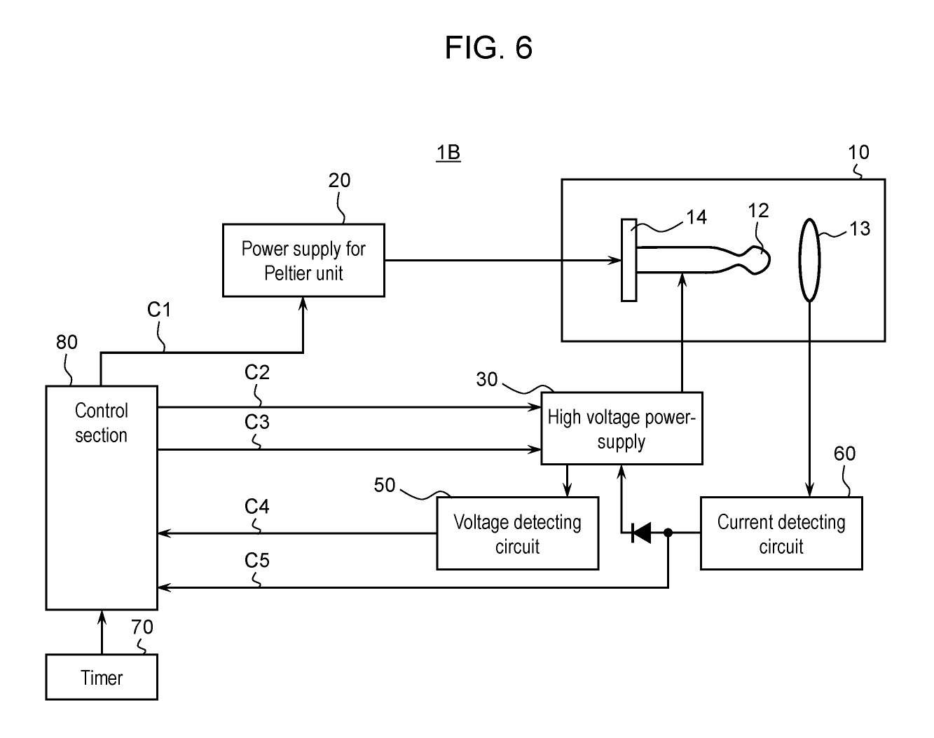

An operation of electrostatic atomizing device 1A in accordance with the first embodiment is demonstrated hereinafter with reference to FIG. 1, FIG. 3, and FIG. 5. FIG. 5 is a flowchart illustrating the operation. When the operation of electrostatic atomizing device 1A starts, the first control mode is implemented, so that atomizing electrode 12 is cooled, and the first voltage is applied to atomizing electrode 12 (step S1).

To be more specific, control section 40 sends control signal C1 for cooling to power-supply 20 for Peltier unit 14, and also sends signal C2 and signal C3 to high voltage power-supply circuit 30, where signal C2 is an ON/OFF control signal that is a command to activate the high voltage power-supply circuit 30, and signal C3 is a voltage adjusting signal for setting the applied voltage to the first voltage.

At the first voltage, the air discharge occurs between atomizing electrode 12 and counter electrode 13, thereby producing minus ions.

The first voltage to be applied at the operation start of electrostatic atomizing device 1A is a voltage at which minus ions are produced. In this embodiment, the first voltage takes a value of, for instance, 4.21 kV.

Upon receiving control signal C1 for cooling, power-supply 20 drives Peltier unit 14 to cool atomizing electrode 12.

ON/OFF control signal C2 sent to high voltage power-supply circuit 30 is a command to operate power-supply circuit 30.

Upon receiving voltage adjusting signal C3, high voltage power-supply circuit 30 generates the first voltage and applies this voltage to atomizing electrode 12, whereby a discharge occurs between atomizing electrode 12 and counter electrode 13.

At the immediately after the operation start, a water (dew) is not yet supplied to atomizing electrode 12, so that the discharge occurs. At this time, the applied voltage is set to the first voltage in order to produce minus ions; however, the applied voltage can be set to a voltage that does not produce the minus ions.

Control section 40 monitors discharge current signal C5 supplied from current detecting circuit 60, and determines whether or not the discharge current decreases to a range that indicates the start of electrostatic atomizing (step S2).

To be more specific, although the applied voltage is kept constant, the discharge current, at which the electrostatic atomizing starts, is smaller than the discharge current at which the air discharge occurs.

While the applied voltage remains at the first voltage from the operation start of electrostatic atomizing device 1A, a decrease of the discharge current to a value, at which the electrostatic atomizing phenomenon occurs, will prompt control section 40 to determine that the electrostatic atomizing phenomenon occurs. The information about the current value at which the electrostatic atomizing phenomenon occurs has been stored in advance in control section 40.

When control section 40 determines that the electrostatic atomizing phenomenon does not occur yet (i.e. branch No of step S2), the process done in step S2 is repeated.

Determining that the electrostatic atomizing phenomenon occurs (i.e. branch Yes in step S2), control section 40 sends voltage-adjusting signal C3 to high voltage power-supply circuit 30, where signal C3 is a command to set the applied voltage to the second voltage. Circuit 30 thus applies the second voltage to atomizing electrode 12 (step S3).

Determining that the electrostatic atomizing phenomenon occurs, control section 40 implements the second control mode. At the second voltage, a rather great amount of the charged particulate water is produced. In this embodiment, the second voltage takes a value of, for instance, 6.27 kV.

The implementation of the second control mode thus allows electrostatic atomizing device 1A to produce the charged particulate water in a stable manner.

### Second Exemplary Embodiment

The electrostatic atomizing device in accordance with the second embodiment is demonstrated hereinafter with reference to the accompanying drawings.

In this second embodiment, a third control mode is implemented after the second control mode in order to change a production amount, after the atomizing phenomenon occurs, of the charged particulate water to a desirable amount.

FIG. 6 is a block diagram illustrating specifically a structure of electrostatic atomizing device 1B in accordance with the second embodiment. In FIG. 6, structural elements similar to those used in the first embodiment have the same reference marks, and the descriptions thereof are omitted here.

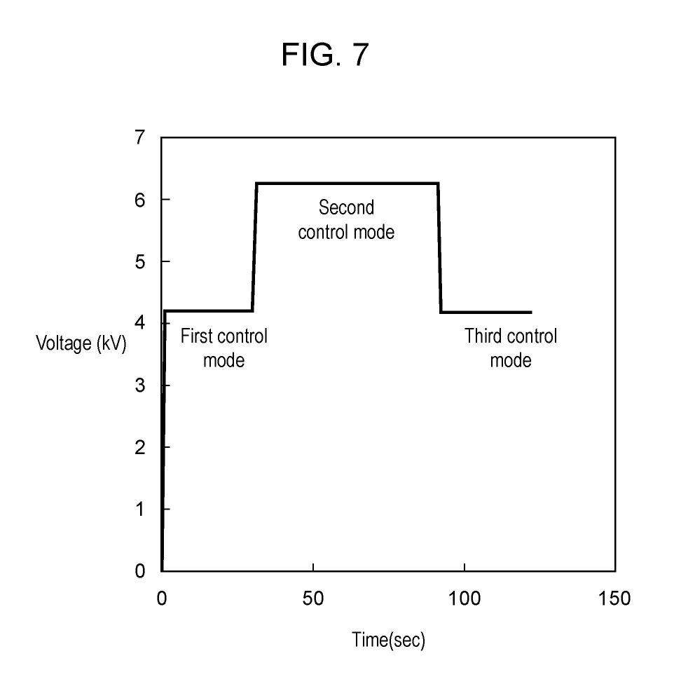

FIG. 7 is a graph showing a relation between a voltage applied to atomizing electrode 12 and a time in device 1B. The vertical axis represents the voltage (kV) applied to electrode 12, and the lateral axis represents the time (second) elapsed from the operation start of electrostatic atomizing device 1B.

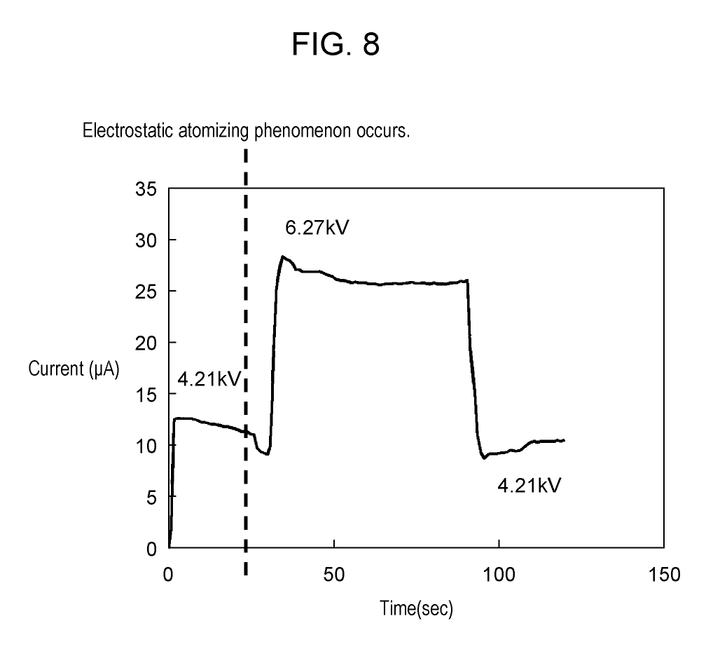

FIG. 8 is a graph showing a relation between the time elapsed from the operation start of electrostatic atomizing device 1B and an amount of a discharge current. The vertical axis represents the amount of discharge current (μA) and the lateral axis represents the time elapsed (second) from the operation start of electrostatic atomizing device 1B.

The first control mode refers to a period during which the applied voltage is set to the first voltage (e.g. 4.21 kV), and the second control mode refers to a period during which the applied voltage is set to the second voltage (e.g. 6.27 kV). The third control mode refers to a period during which the applied voltage is set to a predetermined third voltage (e.g. 4.21 kV).

As FIG. 6-FIG. 8 show, electrostatic atomizing device 1B in accordance with the second embodiment includes control section 80 instead of control section 40 shown in FIG. 3. Control section 80 has the function below in addition to the functions of control section 40.

Control section 80 implements the third control mode after the second control mode besides the first and second control modes. Since the details of the first and second control modes implemented in this second embodiment remain the same as those in the first embodiment, the descriptions thereof are omitted here.

In the third control mode, high voltage power-supply circuit 30 sets the applied voltage to the third voltage different from the second voltage, so that a different amount (per unit time) of the charged particulate water from that produced during the second control mode is produced.

Control section 80 used in the second embodiment thus sets the applied voltage to the second voltage, and then set it to the third voltage different from the second voltage, whereby the production amount of the charged particulate water is changed.

Control section 80 sends voltage-adjusting signal C3, which is a command to set the applied voltage to the second voltage, to high voltage power-supply circuit 30, and prompts timer 70 to start measuring a time elapsed.

When the time measured elapses over a given time, control section 80 sends voltage-adjusting signal C3, which is a command to set the applied voltage to the third voltage, to high voltage power-supply circuit 30, whereby the applied voltage is changed from the second voltage to the third voltage, and the second control mode moves to the third control mode.

The applied voltage is thus automatically changed from the second voltage to the third voltage with the aid of timer 70; however, this change can be done manually with a switch, or this change can be done by combining automatic one and manual one.

The third voltage is set to, for instance, a lower voltage than the second voltage, so that the production amount of the charged particulate water in the third control mode becomes less than that in the second control mode.

The third voltage can be set to a voltage equal to the first voltage, or can be set to a voltage higher than the second voltage. In the latter case, the production amount of the charged particulate water in the third control mode becomes greater than that in the second control mode. The third voltage can be also set to a voltage at which no charged particulate water is produced.

The advantage of changing the applied voltage, namely from the first voltage to the second voltage higher than the first one, and from the second voltage to the third voltage different from the second one, is described hereinafter with a hairdryer as an example. This hairdryer includes electrostatic atomizing device 1B.

It has been known that minus ions and the charged particulate water act on hair with good effect. Use of the first voltage lower than the second voltage as the applied voltage allows shortening the time needed before the charged particulate water is produced, so that the effect of the charged particulate water can be obtained sooner.

Here is another advantage: a setting of the applied voltage to the first voltage, at which the charged section produces the minus ions, allows the hairdryer to supply the minus ions to the hair during a period from the operation start of electrostatic atomizing device 1B until the production start of the charged particulate water.

When the electrostatic atomizing phenomenon occurs and the production of the charged particulate water starts, the applied voltage is changed from the first voltage to the second voltage for increasing the production amount of the charged particulate water. The production amount thereof then reaches to a desirable amount.

Since the charged particulate water contains constituents effective to the hair (e.g. acidic constituent such as nitrate ion), a stable supply of the charged particulate water in the desirable amount allows giving a good effect to the hair.

The hair has been wet before the electrostatic atomizing starts, and the hair contains a great amount of moisture. Since a hair cuticle is open in this condition, a supply of a great amount of the charged particulate water (i.e. a great amount of the foregoing effective constituent) to the hair allows the effective constituent contained in the water to permeate as deep as inside the hair in a great quantity.

When the hairdryer keeps supplying a warm air to the hair, the hair becomes dry gradually, and the moisture in the air decreases. Then the hair cuticle is closed. In this condition, although a great amount of the charged particulate water is supplied to the hair, the water is hard to permeate inside the hair. In this case, it is recommended that the amount of the charged particulate water to be supplied to the hair be reduced for tightening the hair cuticle so that the moisture in the hair can be retained.

When a given time elapses after the applied voltage is set to the second voltage, control section 80 thus changes the applied voltage from the second voltage to the third voltage lower than the second one, thereby reducing the production amount of the charged particulate water.

The duration of the second voltage, namely, a time needed from the operation start of the hairdryer until the hair becomes somewhat dry, is set in advance based on an experiment, and is stored in control section 80. Since a greater amount of hair needs a longer time for being dried, the hairdryer can be provided with a switch for users to select a set time.

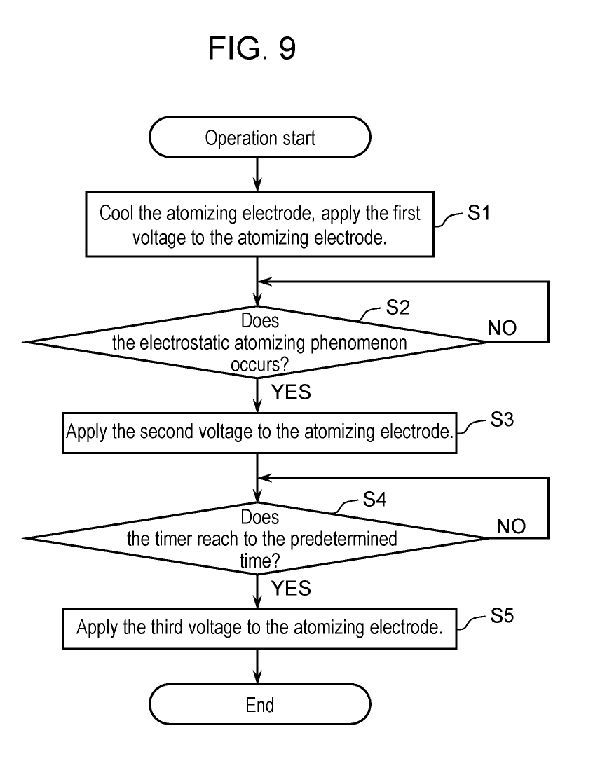

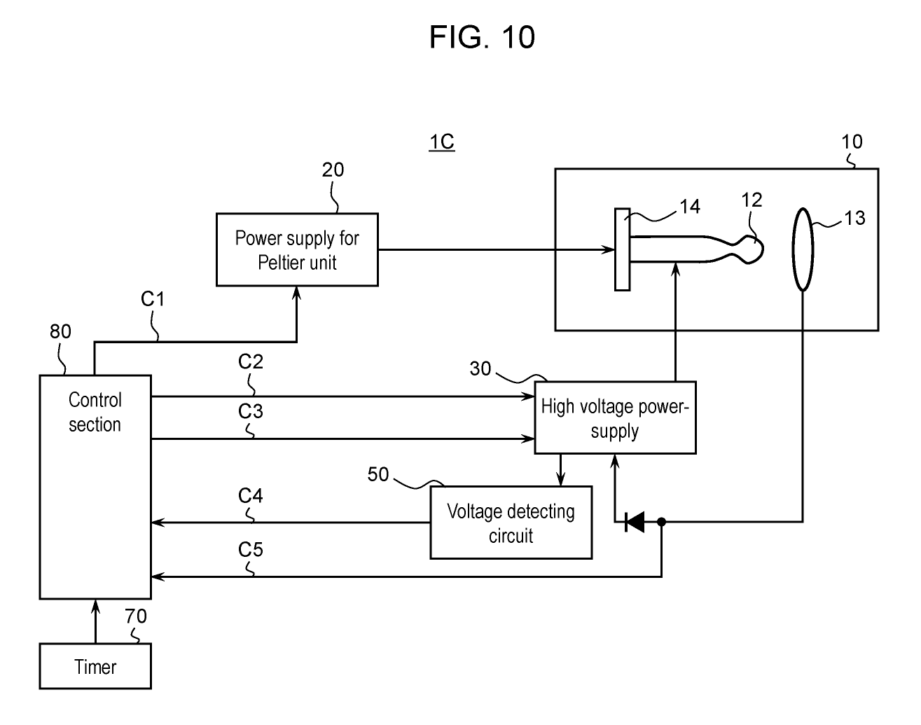

An operation of electrostatic atomizing device 1B in accordance with the second embodiment is demonstrated hereinafter with reference to FIG. 6 and FIG. 9. FIG. 9 is a flowchart illustrating the operation, and steps S1, S2, and S3 remain the same as those of the flowchart shown in FIG. 5, so that the descriptions thereof are omitted here.

Control section 80 sends voltage adjusting signal C3 to high voltage power-supply circuit 30, where signal C3 is a command to set the applied voltage to the second voltage, and drives timer 70. Control section 80 then determines whether or not the time measured with timer 70 reaches to the foregoing set time (step S4).

When control section 80 determines that the measured time does not yet reach to the set time (branch No of step S4), the process done in step S4 is repeated.

When control section 80 determines that the measured time reaches to the set time (branch Yes of step S4), control section 80 sends voltage adjusting signal C3 (i.e. the command to set the applied voltage to the third voltage) to high voltage power-supply circuit 30, whereby circuit 30 applies the third voltage to atomizing electrode 12 (step S5).

### Third Exemplary Embodiment

An electrostatic atomizing device in accordance with the third embodiment is demonstrated hereinafter with the accompanying drawings. A method of determining whether or not the electrostatic atomizing phenomenon occurs is different from that described in the second embodiment.

FIG. 10 is a block diagram illustrating a structure of electrostatic atomizing device 1C in accordance with the third embodiment. In FIG. 10, structural elements similar to those used in the second embodiment have the same reference marks, and the descriptions thereof are omitted here.

In the second embodiment previously discussed, control section 80 determines, based on the value of the discharge current, whether or not the electrostatic atomizing phenomenon occurs.

In this third embodiment; however, control section 80 determines, based on a time elapsed from the operation start of electrostatic atomizing device 1C, whether or not the electrostatic atomizing phenomenon occurs. To be more specific, device 1C does not include current detecting circuit 60 shown in FIG. 6.

The time needed from the discharge start until the electrostatic atomizing phenomenon occurs has been studied in advance based on an experiment and is stored in control section 80. When the time elapsed from the setting of the applied voltage to the first voltage reaches to the time stored, control section 80 thus determines that the electrostatic atomizing phenomenon occurs.

Control section 80 thus changes, based on the time elapsed from the operation start, the first control mode to the second control mode.

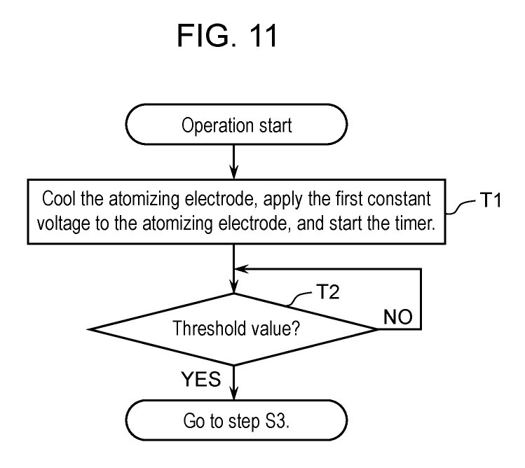

An operation of electrostatic atomizing device 1C in accordance with the third embodiment is demonstrated hereinafter with FIG. 10 and FIG. 11 which is a flowchart illustrating the operation.

The operation start of electrostatic atomizing device 1C allows cooling atomizing electrode 12, applying the first voltage to atomizing electrode 12, and starting timer 70 (step T1). The cooling of atomizing electrode 12 and the application of the first voltage to atomizing electrode 12 remain the same as those steps done in the second embodiment, so that the descriptions thereof are omitted here.

Control section 80 determines whether or not the time measured with timer 70 reaches to the time stored in control section 80 (step T2). In the case of determining ‘not yet reaching to the time’ (branch No of step T2), the process done in step T2 is repeated.

In the case of determining ‘reached to the time’ (branch Yes of step T2), the process thereafter remains the same as the process done in steps S3-S5 shown in FIG. 9, so that the description thereof is omitted here. The process in step T1 and step T2 can replace the process in step S1 and step S2 shown in FIG. 5 in accordance with the first embodiment.

The electrostatic atomizing device of the present disclosure is not limited to the structures demonstrated in the embodiments discussed previously, but is applicable to every possible combination of the embodiments. The structural elements described in the embodiments can be changed appropriately to alternative means as long as they do not deviate from the gist of the present disclosure.

### INDUSTRIAL APPLICABILITY

The principle of the present disclosure is applicable to devices that produce the charged particulate water.

### DESCRIPTION OF REFERENCE MARK

1A, 1B, 1C electrostatic atomizing device
2 discharge section
3 voltage applying section
4, 40, 80 control section
10 atomizing block
12 atomizing electrode
13 counter electrode
14 Peltier unit
20 power supply for Peltier unit
30 high voltage power-supply
50 voltage detecting circuit
60 current detecting circuit
70 timer

1. An electrostatic atomizing device comprising:
a discharge section capable of retaining a liquid;
a voltage applying section for applying a voltage to the discharge section; and
a control section for controlling the voltage applied by the voltage applying section,
wherein the control section sets the applied voltage to a predetermined first voltage at an operation start of the electrostatic atomizing device, and then sets the applied voltage to a predetermined second voltage at which a desirable amount of a charged particulate water is produced, the second voltage being higher than the first voltage.

2. The electrostatic atomizing device according to claim 1, wherein the control section sets the applied voltage to a predetermined third voltage different from the second voltage after setting the applied voltage to the second voltage.

3. The electrostatic atomizing device according to claim 2, wherein the third voltage is equal to the first voltage.

4. The electrostatic atomizing device according to claim 1, wherein the first voltage is a voltage at which minus ions are produced in the discharge section.

5. An electrostatic atomizing method for producing a charged particulate water by applying a voltage to a liquid accommodated in a discharge section, the method comprising the steps of;
a first step of applying a first voltage to the liquid at an operation start of the electrostatic atomizing device; and
a second step of applying, to the liquid, a predetermined second voltage higher than the first voltage after the first step,
wherein the second voltage is a predetermined voltage at which a desirable amount of the charged particulate water is produced.

6. The electrostatic atomizing method according to claim 5 further comprising
a third step of applying, to the liquid, a predetermined third voltage different from the second voltage after the second step.
